(19) United States
(12) Patent Application Publication
(10) Pub. No.: US 2003/0209005 A1
(43) Pub. Date: Nov. 13, 2003

(54) Wick injection of liquids for colloidal propulsion

(76) Inventor: John Bennett Fenn, Richmond, VA (US)

Correspondence Address: John B. Fenn, 4909 Cary Street Road, Richmond, VA, 23226, US

(21) Appl. No.: 10/143,686

(22) Filed: May 13, 2002

(51) Int. Cl. F03H 1/00

(52) U.S. Cl. 60/203.1; 60/204

(57) ABSTRACT

Propellant liquid is supplied to a Colloidal Thruster for Micro-Satellite vehicles in Space by capillarity induced flow through a wick element comprising a permeable porous aggregate of fibers or particles of material that is wetted by the propellant liquid. An intense electric field at the tip of the wick element dispersed the arriving liquid into a fine spray of charged droplets. Electrodes having appropriate design, location and potentials accelerate the charge droplets to high velocity, thereby providing reactive thrust to the vehicle. In this method of propellant liquid introduction the flow rate and exhaust velocity, and therefore the thrust level, are determined by the applied potential difference, thereby eliminating the need for pumps or pressurized gas and flow controllers to provide the desired flow-rate for the propellant liquid.

### I. BACKGROUND

For a variety of reasons there has recently been a growing interest in the possibilities of using very small satellites and probes for some space missions. This interest in “miniaturization” has stimulated a renewal of research in so-called “colloidal propulsion”, the production of thrust by electrostatic acceleration of highly charged droplets or particles of nonvolatile liquids. Such use of charged droplets as propellants has its roots in studies carried out during World War I by John Zeleny, a physicist at Yale. He found that if a small-bore thin-walled tube was maintained at a high electrostatic potential relative to its surroundings or an opposing electrode, the electric field at the tube tip could be sufficiently intense to disperse an emerging conducting liquid into the ambient gas (air) as a fine spray of charged droplets [1]. (These tubes are frequently referred to as “spray needles” because they often comprise a short length of the stainless steel tubing from which hypodermic needles are produced.) Except for an occasional paper, this “electrospray” phenomena remained pretty much a laboratory curiosity until the 1960's when two prospective applications for sprays of charged droplet emerged. First came the realization that non-volatile liquids could be electrosprayed into vacuum wherein electrostatic acceleration of the droplets to high velocities might be a useful source of thrust for vehicle propulsion in space. Earlier studies on the development of “ion engines” based on the acceleration of atomic ions had shown that very high specific impulses could indeed be achieved. However, to achieve useful ratios of thrust to power would require “ions” with much higher mass/charge ratios than ions comprising electron deficient atoms could provide. Thus, Krohn [2], Huberman [3], Huberman and Rosen [4], Kidd and Shelton [5] and others had carried out studies on the thrust produced by acceleration of charged liquid droplets. In 1999 Martinez-Sanchez et al provided an extensive review of the research on what is now often referred to as Colloid Propulsion (CP) [6]. More recently, Gamero-Castano and Hruby have provided detailed results obtained during an extensive study on the performance of such a thruster over a range of operating conditions and liquid compositions [7].

The second prospective and intriguing possible application for Zeleny's charged droplets was proposed in 1968 by Malcolm Dole [8]. Zeleny had noticed that if the liquid was volatile, evaporation would shrink each charged droplet until at some point it would become un-stable and suddenly disrupt into a plurality of smaller “offspring” droplets. The disruption was due to the increase in droplet charge density occasioned by evaporative shrinking to the point where Coulomb repulsion overcame the surface tension that held the droplet together. This instability-disruption phenomenon, sometimes referred to as a “Coulomb explosion,” had been predicted and characterized in 1882 by Lord Rayleigh [9]. Dole's idea was that the “offspring” droplets resulting from the Rayleigh instability would repeat the evaporation-disruption sequence. If the electrosprayed liquid comprised a dilute solution of large polymer molecules in a volatile solvent, a series of these evaporation-disruption sequences should ultimately produce droplets so small that each one would contain only a single polymer molecule. As the last of the solvent evaporated that molecule would retain some of its droplet's charge and thus form an intact gaseous ion, even from a species much too large and fragile to be vaporized for ionization by traditional methods such as Electron Impact (EI). Dole hoped that analysis of the resulting ions with a msss spectrometer would provide a route to the long sought goal of determining the molecular weight distributions in synthetic polymers. Unfortunately, for a number of reasons, his attempts to reduce this idea to experimental practice were not successful enough to spark much interest in other investigators. In 1974, consequent to their previous research in producing charged droplets for Colloidal Propulsion (CP) Simons et al introduced Electrohydrodynamic Ionization (EHDI) by reporting the production of ions from some solute species in charged droplets of solutions electrosprayed directly into vacuum. In order to avoid “freeze drying” of the liquid droplets due to rapid evaporation rate in vacuo they had to use non-volatile solvents such as glycerol [10]. The low volatility of these liquids together with the absence of ambient bath gas as a source of evaporation enthalpy made droplet vaporization too slow to be completed so that ion yields were low. Even so, for the next decade or so several investigators pursued EHDI but it never achieved much of a following. Not only did the absence of bath gas inhibit droplet evaporation, it also eliminated most collisions between any ions that were formed and neutral gas molecules. The net result was that the ions retained much of the kinetic energy with which they were born, i.e. a substantial fraction of the difference in potential between the source needle and ground or counter electrode. Thus, most ion energies were in the range of one or more kilovolts, so high that the only mass analyzers that could accommodate them were large and very expensive magnetic sector instruments. For these and other reasons EHDI never became a viable ionization method. In 1986 Cook published a fairly comprehensive review of EHDI research up to that time [11]. Not much has happened since then.

In 1984 Yamashita and Fenn at Yale [12] as well as Alexandrov et al in Leningrad [13] both showed that if certain precautions were observed Dole's idea of electrospraying solutions into into bath gas worked very well in producing ions with small solute molecules. A few years later the Yale Group showed that EDI could produce intact ions from proteins having molecular weights of at least 50,000 with no evidence of any upper limit in size [13]. Moreover, the number of charges per ion increased with molecular weight so that the mass/charge ratio hardly ever exceeded about 2500. That report triggered an explosive growth in Electrospray Ionization Mass Spectrometry (ESIMS), a technique that has revolutionized the analysis of the large and fragile molecules that play such a vital role in living systems. In 2001 the number of papers per year based on ESIMS reached over 1600 and is still climbing. The world population of ESIMS instruments is now over 10,000. It is noteworthy that in spite of the effectiveness and widespread use of ESIMS, the mechanisms by which solute species become gas phase ions during evaporation of charged droplets remains a subject of much contention and debate!

There are major differences between these two applications of Zeleny's electrospray dispersion, i.e. the use of charged droplets as a source of ions for mass spectrometry, or as a “working fluid” in Colloidal Propulsion (CP) thrusters. In ESIMS the liquids have to be sufficiently volatile to evaporate fairly quickly and the droplets must be dispersed in a gas at a temperature and pressure sufficiently high to provide the enthalpy necessary for evaporating the solvent. In CP thrusters the sprayed liquids are as non-volatile as possible and are dispersed into vacuum. Even so, the fundamental processes of dispersing the liquid into charged droplets by electrostatic fields are very similar in the two cases.

II. The Spray Stability Problem.

Microscopic examination of a stable electrospray shows that the liquid emerging from the tip of the spray needle forms a conical meniscus known as a “Taylor cone” in honor of G. I. Taylor whose theoretical analysis predicted that a dielectric liquid in a high electric field would take such a shape [15]. In the case of conducting liquids a fine filament or jet of liquid emerges from the cone tip. An interaction between surface tension and viscosity, also first analyzed by Rayleigh, produces so-called varicose waves along the jet surface [16]. Those waves grow in magnitude to the point where they pinch off segments of the filament having a uniform length. Surface tension transforms each such segment into a spherical droplet. The net result is a stream of droplets of uniform size with diameters slightly larger than the diameter of the jet. Because all the droplets have a net charge of the same polarity, Coulomb repulsion disperses their trajectories into a conical array. Sprays produced under these circumstances are often known as “cone-jet” sprays.

It turns out that to obtain a stable cone-jet electrospray one must achieve and maintain an optimum balance between liquid flow rate and the applied field. Moreover that optimum balance depends very strongly on the properties of the liquid, in particular its electrical conductivity, surface tension and viscosity. In general, the higher the conductivity and surface tension, the lower must be the flow rate. Introduction of liquid at a desired rate is usually achieved either with a positive displacement pump or by pressurizing a reservoir of the sample liquid with gas. In the latter case the conduit from the reservoir to the spray tip must be long enough and narrow enough to require a high pressure difference between the source and the exit of the spray needle to maintain a steady flow into the Taylor Cone at the end of the conduit. If that pressure difference is very high relative to the pressure at the needle exit, minor pressure fluctuations at the needle tip or in the ES chamber will not appreciably affect the liquid flow rate. Thus a stable steady flow can usually be maintained for a particular liquid by appropriate choice of reservoir gas pressure. In the case of a positive displacement pump, of course, the liquid flow rate can be maintained at any value for which flow rate and liquid properties are consistent with stability.

Whether it is achieved by a pump or pressurized gas, or by any other means, the flow rate required for stability must be prescribed a apriori and a control system must be provided that can maintain the flow rate at the prescribed value. Neither of these requirements is all that easily met, especially when it may be necessary to vary over an appreciable range the level of thrust from any single spray. Because the level of thrust from a single spray element is inevitably small, it is very likely that any one vehicle will require a multiplicity of spray elements to provide the variability in magnitude and direction of thrust that may be required. Such multiplicity greatly compounds the already significant problems of specifying and controlling the flow rate of propellant to a single spray thruster.

There is another complication that can be encounterd. Because the flow to any single spray thruster element is necessarily quite small, the flow diameter in a channel or duct that introduces the liquid to the region of high electric field is also small. Consequently, even a very small particle of dirt may partially or completely clog the channel that is supplying liquid to the spray so that a higher pressure may be required to maintain the flow at the required flow. If the flow is being maintained by pressurized gas, the driving gas pressure would then have to be increased and then released again if the plug clears. To achieve such a variation in the pressure needed to maintain a specified flow rate would require a control systems and a reserve supply of gas that would add both complexity and mass to the system. If, on the other hand, an appropriate liquid flow rate is maintained by positive displacement pump, a complete or partial clogging of the feed line might stall the pump or cause a rupture somewhere in the line. To insure against such a damaging failure while maintaining a desired thrust level would also require fairly elaborate control systems. Thus, for missions requiring varying thrust levels at different stages, the control system needed to adjust the flow rate and/or applied voltage while maintaining flow stability is likely to add undesirable cost, complexity and mass along with decreasing reliability.

### III. BRIEF DESCRIPTION OF THE INVENTION

The present invention takes advantage of some recent findings in our laboratory that offer promise of overcoming many of the stability, control and plugging problems that might be encountered in the use of colloidal thrusters for small spacecraft. The underlying idea is to use capillarity driven flow rather than hydrostatic pressure or a mechanical pump to supply liquid to the high field region where the liquid is dispersed into charged droplets which are accelerated to provide reactive thrust. A key characteristic of flow driven by capillarity forces is that those forces can drive the liquid only to the extremity of the capillarity element. Thus, for example, if a vertical wick comprising a strip of filter paper or cloth is suspended with one end dipping beneath the surface of water in a beaker, water will migrate through the wick, driven by capillarity. If the wick is jacketed or the ambient gas is saturated with water vapor so there is no evaporative loss of water from the wick, then the capillarity driven flow of water will cease when the wick becomes saturated with liquid, i.e. is wet throughout its length. If the surrounding gas is not saturated with water vapor then water will be lost from the wick by evaporation. The flow of water up the wick by capillarity will thus continue at a rate just sufficient to compensate for the evaporative loss and the wick will remain saturated with liquid. If the wick is long enough the liquid will only reach the height at which downward gravitational force due to the weight of the liquid column is equal to the attractive force between the wick substance and the liquid molecules at the top of the column. If the wick is long enough to reach over the rim of the beaker and hang down the outside so that its end is at or below the surface level of the water in the beaker, and if capillarity flow is established througout the wick length, water will drip from the end of the wick and capillarity driven flow will continue from the beaker water through the wick until the beaker water is so depleted that it loses contact with the wick. In sum, capillarity forces can drive liquid through a wick until the liquid reaches the end of the wick, or until it reaches a location in the wick at which the sum of any opposing external forces becomes equal to or greater than the net capillarity force resulting from a stronger attraction of the liquid molecules for the wick substance than for each other. Such capillarity-driven flow will cease when the loss of liquid from the wick ceases or when the wick loses contact with the source liquid, whichever comes first. If, on the other hand liquid arriving at the end of the wick is removed, capillarity driven flow will attempt to replace the departing liquid at just the rate it is removed. Clearly, the maximum flow rate capillarity can provide may be less than the possible removal rate by the field. In that case the field will remove the liquid only as fast as the capillarity flow rate can supply it. Just as clearly, the capillarity flow rate achievable by a particular combination of wick and liquid may be greater than the rate at which the field can remove it. In that case again the actual flow through the wick will be at exactly the rate at which the field can remove it. In sum, when an appropriate wick is used to supply liquid to a region of high electric field for electrospray dispersion, the system will automatically adjust itself to produce a stable spray. For particular combination of wick and liquid the rate at which the liquid is dispersed into charged droplets will depend on the strength of the field, i.e. the applied voltage. Thus, capillarity driven flow automatically provides liquid to the tip of the wick at exactly the rate at which liquid is removed from the tip. Familiar examples in which this self-balancing feature of wick flow occurs include candles and oil lamps. In those devices the flame that provides the illumination simultaneously consumes the liquid fuel evaporating from the wick and supplies the heat needed to maintain the evaporation rate. Similarly, in the case of removal of liquid into an electrospray by an applied electric field, a wick will supply liquid only at the rate at which it is dispersed by the field. The system is thus inherently stable with the flow rate being determined by the dimensions of the wick, the applied voltage, properties of the liquid and the properties of the wick substance.

A tacit assumption in this description of wick flow is that the liquid wets the wick. Clearly, for example, capillarity driven flow of water will not take place through a wick of teflon fibers which are not wet by water. Similarly, a liquid that is largely composed of hydrocarbons will not be driven by capillarity through a cotton wick that is wet with water when the hydrocarbon arrives. Of course, hydrostatic pressure can overcome a lack of wettability and thus force the flow of a liquid through a wick that comprises a tube packed with porous material that is not wet by the liquid. This is the situation that obtains in so-called “Reverse Phase Liquid Chromatography” which requires a very large pressure drop to force the liquid through a matrix of material it does not wet. The subject invention relates only to flow through a wick of a liquid that wets the wick substance and is driven by capillarity rather than hydrostatic pressure.

### III, DETAILED DESCRIPTION OF THE INVENTION

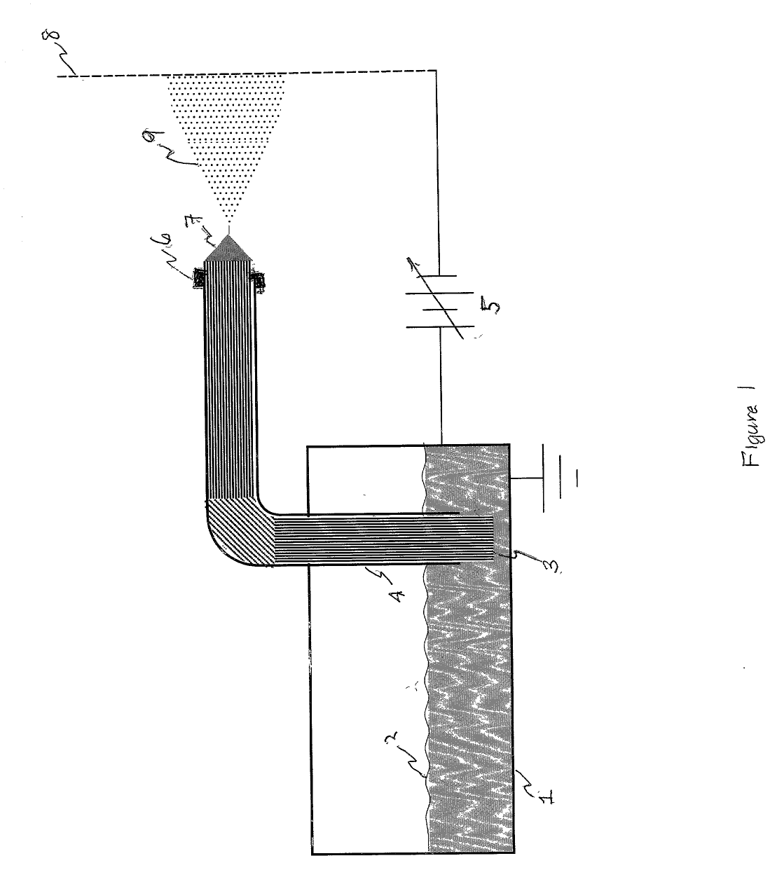

We have found that very stable electrosprays are readily produced when capillarity driven flow through a wick structure introduces a relatively nonvolatile conducting liquid into a high field region at very low pressure or in vacuum. FIG. 1 shows schematically the essential features of an arrangement by which such an electrospray is readily produced. Grounded reservoir 1 contains a supply of propellant liquid 2 having a low volatility. Wick 3, of a porous material wettable by liquid 2, extends from immersion in liquid 2 through conduit 4, terminating at or near its exit plane. It may sometimes be desirble to let the wick extend for a short distance beyond that exit plane. A seal 7 placed at the exit end of the tube limits leakage of liquid by flow around the wick. Such a seal may comprise a drop of cement that is allowed to set while the wick is dry and before liquid is added to reservoir 1. The cement should be such that it is not soluble in liquid 2 after it has set. Alternatively, a suitable plug may comprise a plug of soft plastic material, also insoluble in the liquid, through which a needle whose eye is “threaded” by the wick may be pushed. The plug may then be compressed into the end of tube 4 thus providing a seal that will allow liquid to flow through the wick but not around it, i.e. between its outside surface and the inner wall of tube 4. We have also found that a sewing needle can be used to pull the wick through a thin film or membrane of rubber or elastic polymer while it is stretched. When the stretching force is released the return of the membrane to its original dimensions can provide a tight enough fit around the wick to minimize leakage. The membrane may then be wrapped around the tube and bound to its outside surface by a winding of wire or string. Indeed, one can also provide an effective seal with one of the several varieties of compression packing glands, tees and couplings widely used for in chromatography “plumbing.” Such glands must not be so “tight” that they compress the wick substance to the point where the capillarity driven flow is reduced to the extend that the desired flow rate cannot be achieved. Other ways to provide seal 7 between the wick and the tube will be apparent to those reasonably skilled in the art of plumbing on a miniature scale. In general the end of the wick should be approximately flush with the exit plane but it may be desirable in some cases that it extends slightly beyond or before that exit plane. The main point is to avoid a wettable surface by which liquid 2 can be lost to the surroundings by creeping flow from the wick along that surface.

Also to be remembered is that capillarity driven flow through a wick does not depend upon body forces on the liquid due, for example, to hydrostatic pressure, gravity or centrifugal acceleration. Indeed, such forces can accelerate, inhibit, stop or even reverse capillarity driven flow. For this reason the propellant liquid in a system like the one illustrated in FIG. 1 must be confined or constrained during periods in which the vehicle may be subject to such forces, e.g. during launch. How such problems can be addressed are beyond the scope of the subject invention which deals primarily with the problem of supplying propellant liquid for electrospray dispersion into charged droplets that can be electrostatically accelerated to provide thrust at the low levels required for positioning or slow maneuvering of a small satellite.

Opposite the end of the wick is an open mesh electrode 8 maintained at a potential relative to the grounded wick sufficient to provide at the wick tip the field necessary to disperse the liquid into an electrospray of fine droplets. Power supply 5 provides a potential difference between the wick and electrode 8 that determines the intensity of the field at the wick tip. The intensity of that field determines the rate at which the liquid flows through Taylor cone 6 into a thin jet of liquid from the cone tip (not shown) which breaks up into the charged droplets that form electrospray 10. The kinetic energies and therefore the velocities of the charged droplets that arrive at the plane of electrode 8 are determined primarily by the potential difference between that electrode and wick 3 but are somewhat less that that potential difference because of the electrical resistance of the liquid in the Taylor cone and especially the thin jet of liquid that issues from its tip. The mesh grid of electrode 8 should be as open, i.e. “transparent”, as possible so as to pass as large a fraction as possible of the arriving droplets. Additional mesh electrodes (not shown) may be located beyond electrode 8 to provide the desired translational energy and therefore velocity of the droplets leaving the vehicle. That departing velocity is what determines the impulse or thrust provided to the vehicle per unit mass of droplets. It may be desirable to provide additional electrodes “downstream” from electrode 8 so that the effective exhaust velocity of the droplets can be specified somewhat independently of the field at the wick tip that governs the size of the droplets and the rate at which they are formed.

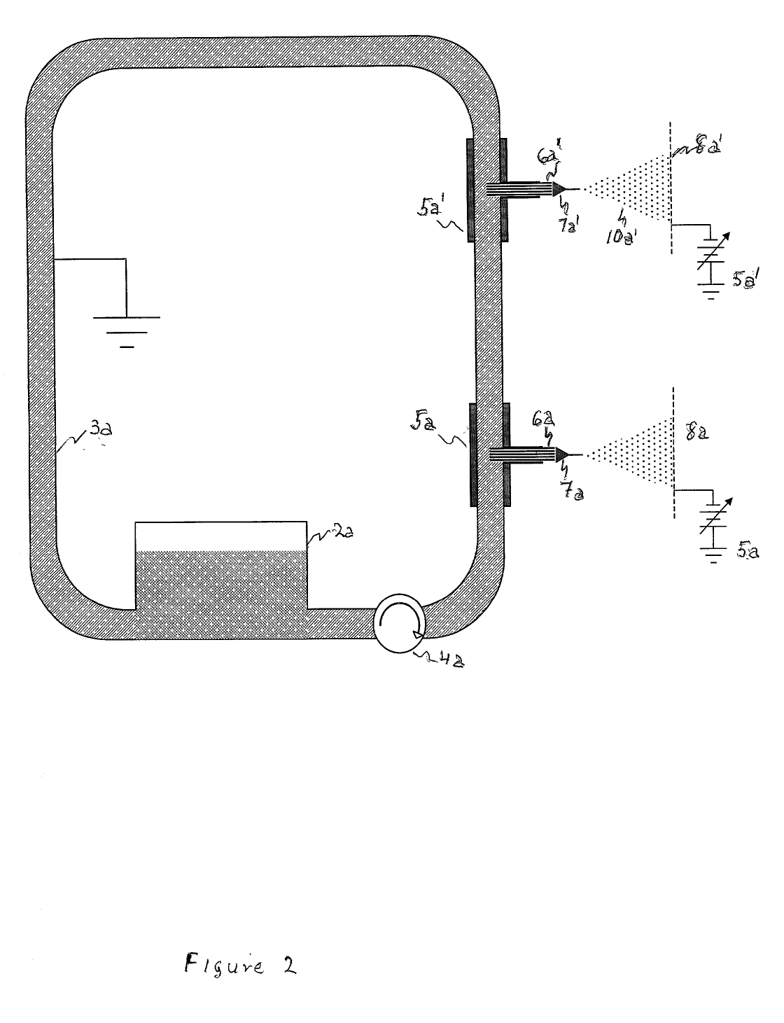

FIG. 1 illustrates the essential features of the invention as they might be embodied in a single thrust-producing element. However, depending upon the size of the vehicle, there may be a need for providing more thrust than one such thrust-producing element can provide. Moveover, it seems likely that in many applications there may also be a need for thrust vectors of different directions and magnitudes from more than one location on the vehicle. FIG. 2 shows schematically how such a plurality of thrust-producing elements might be be provided.

With reference to FIG. 2 reservoir 2a contains a supply of propellant that flows continuously through the loop of conduit 3a back to reservoir 2a. Flow of propellant liquid through that loop is maintained by pump 4a. It is to be understood that the actual path of conduit 3a en route from reservoir 2a and back, passes near all locations on the vehicle at which a thruster is to be located. At each such location there is a tee in the conduit. Two examples of such “tees” are represented by 5a and 5a′ along conduit loop shown schematically in FIG. 2. A wick is inserted in the arm of each tee (6a and 6a′) so that its interior end is bathed by the liquid circulating in the loop. The wick extends to the exit plane of the tee arm, or slightly beyond, and is provided with a seal as explained in the description of FIG. 1. Opposite the tip of each wick is a mesh electrode (8a and 8a′) as in FIG. 1 that can be maintained at a desired potential relative to their opposing wicks (6a and 6a′) by power supplies 5a and 5a′ respectively. When a sufficiently high potential is applied to electrodes 8a and 8a′ a Taylor cone of liquid (6a and 6a′) will be formed at the end of each wick. From the tip of each cone emerges a filament or jet of liquid (not shown) which breaks up or disperses into an electrospray of charged droplets (10a and 10a′) Clearly, this method of providing two separate wick injectors from a single source of liquid can be readily expanded to produce a plurality of such wick injectors, each with its own counter electrode comprising a highly open or transparent grid electrode 8. In addition, each such separate grid electrode 8 can be followed by subsequent similar electrodes whose potentials can be maintained any desired level by an appropriately adjustable power supply, or plurality of power supplies such that the potential of each electrode on each thruster can be maintained at a desired level by methods well known to those skilled in the art of designing electrical power supplies and their controls. In sum, by procedures such as those just described, a plurality of electrospray thrusters can be easily distributed on a particular vehicle in such a way that each one provides thrust vector in its particular direction. A desired magnitude for that thrust vector can be obtained by an appropriate choice of voltages on each electrode associated with that thruster. An appropiate combination of thrust magnitudes for each of the said plurality of thrusters can provide a resultant thrust vector for the vehicle as a whole in any desired direction over a range of magnitudes. Thus, the position and velocity of the vehicle can be varied over a wide range thereby providing readily controlled maneuverability. It is noteworthy that the only variables that need to be controlled are voltages.

This wick injection takes advantage of the self-balancing feature of capillarity-driven flow, namely the fact that such flow will occur only at a rate sufficient to replace liquid that is removed, for example by combustion in a candle or by field dispersion in electrospray. In the latter case the field is produced by potential difference between the wick and the counter electrode. The required potential difference is created by connecting the wick to one pole of an appropriate power supply, the other pole of which is connected to the counter electrode. A wick wet with conducting liquid is itself a good electrical conductor so that the wick connection to the power supply can be made anywhere along the wick or to the reservoir of liquid in which one end of the wick is immersed. Capillarity drives the liquid to the tip of the wick where it forms the same kind of cone=jet configuration that occurs at the end of a small diameter tube maintained at high potential in conventional electrospray systems. In the case of a tube, the diameter of the cone base generally equals the effective flow diameter at the tube exit, i.e. its bore. In the case of a relatively porous wick that flow diameter very close to the diameter of the wick. With wicks of very small dimensions it is sometimes not possible to see the cone-jet configuration of liquid at the wick tip. Even so when one can detect a measurable spray current between the wick and the counter electrode and a slow but measurable flow of liquid through the wick, one can be reasonably be sure that the cone-jet configuration obtains. Indeed in every case when there has been a detectable current, a cone has become visible when viewed with sufficient magnification. Numerous experiments have clearly shown that with wick injectors both total current in the spray and selected ion currents at the detector of the mass analyzer are remarkably steady even with liquids having high conductivities and/or high surface tensions. When gas pressure or a pump is used to supply liquid at very low flow rates it can be very difficult to obtain and maintain the flow rate required for a stable spray. Thus, wick injection of liquid into an electrospray provides convenient and effective flow control and stability. Also noteworthy is the fact that in the case of the wick the magnitude of the flow rate is determined by the strength of field, i.e. the applied voltage. Thus, in the case of a colloidal thruster one can control and vary the thrust over a substantial range, simply by adjusting the voltage. Indeed, though it has not yet been investigated, one can contemplate the possibility of providing impulse thrust in very short bursts, a procedure that might be very useful in achieving accurate control of the position and orientation of a small satellite. Because of the inherent simplicity and ruggedness of the hardware required for producing a wick spray, it should be fairly easy to provide wick thrusters at various positions on the satellite. All such thrusters might obtain the propellant liquid from a single common source or they might be fed from a plurality of sources at strategic locations in the satellte. Such an arrangement could provide net thrust vectors of readily variable magnitudes in almost any direction. A systematic study to determine the optimum structure and composition for useful wicks has not been carried out but successful operation has been obtained with wicks comprising bundles of small fibers made of glass, graphite, paper, cotton and linen that have ranged in diameter from 8 to perhaps 200 microns. Nor is the cross sectional shape important. Thin flat strips of cloth or paper work just as well as threads or fibers of circular or oval cross section. Tubes packed with granular or porous material can also be used. An effective wick can comprise a single monofilament fiber in a tube whose bore has a diameter only slightly larger than that of the wick. If the thickness of the annular gap between wick and tube is sufficiently small, and if the attractive forces between molecules of liquid and the surfaces of the fiber and filament are sufficiently larger or smaller than the attractive forces of the molecules for each other, capillarity can either lift the level of liquid in the tube to a substantial height above the surface level of liquid in which this filament-cylinder wick is immersed, or lower the level liquid in tube below the level of that outside surface level. Of course, if liquid is to be electrosprayed from this or any other type of wick, acceleration or gravitational forces must not be so strong that capillarity is unable to pull the liquid from the supply container and raise it to the tip of the tube where the applied electric field can pull it into the spray. Unwaxed dental floss seems to work very well so a short length of this material has comprised the workhorse in the use of wick injectors for ESIMS. However, successful operation has also been achieved with wicks comprising fibers of glass, carbon and a wide range of natural and synthetic polymers. The necessary and sufficient property of the fiber substance is that it be wettable by the liquid. In bench-top experiments with electrometer measurements of total spray current we have readily obtained apparently-stable “sprays” with a wide variety of liquids. Gradually increasing the applied voltage results in a smooth very gradual transition to a corona discharge that seems to be readily reversible without the usual hysteresis loop.

This use of capillarity driven flow through a wick to supply an electrospray has been found effective and useful in Electrospray Ionization Mass Spectromety (ESIMS) as taught in U.S. Pat. No. 6,297,499 B1 [17]. In that application the objective is to disperse a solution of analyte species as charged droplets into an inert bath gas, typically at or near atmospheric pressure. The bath gas then provides the enthalpy that evaporates solvent from the droplets, thereby transforming solute species in the droplets into gaseous ions that can then be analyzed by mass spectrometry. Thus, the liquid must be volatile and the dispersion must be into a gas which provides the enthalpy required for vaporization. In this space propulsion application the electrospray dispersion must be carried out in vacuum and liquid must have as low a vapor pressure as possible to avoid evaporative losses of mass from the droplets before they have been accelerated to provide reactive thrust as well as to minimize evaporative losses of the propellant liquid during extended periods in space. The vitalizing feature of present invention is the discovery that wick injection does work beautifully in vacuum, thus providing a simplicity and flexibility which are always at a premium in space propulsion applications.

The requirement in space propulsion for liquids with ultra low vapor pressures also raised questions to which answers were needed. It turned out that such liquids did work with wick injection and we have found a number of liquids with very low vapor pressures that seem to work very well. They include amides, alcohols, glycols, esters, ketones and mixtures of one or more of these compounds. Of particular interest are so-called “ionic liquids” that comprise organic mixtures of cations and anions with polyatomic “superstructures” surrounding the charge bearing groups that prevent charges of of opposite sign from coming so close together that they become in effect a neutural particle. In a sense the substance of the molecule outside the charge plays a role similar to that of water in an electrolyte solution by forming a cage that keeps the cations and anions separated from each other. There is a great variety of these materials which are effective solvents for many species properties and very low vapor pressures. These characteristics have made them increasingly attractive candidates as media in which to carry out chemical synthesis on an industrial scale. Stable electrosprays have been obtained with representative candidates from a variety of most of this class of liquids.

In sum, the key feature of the invention is the use of capillarity-driven flow through a wick element to provide self stabilizing electrosprays of tiny charged droplets in vacuum: Various other applications of this discovery will no doubt suggest themselves to other investigators who understand the nature of the invention.

1. A method of producing a stream of small charged droplets in a low pressure environment that includes the following essential steps.
(a) providing a wick element through which capillarity forces induce a flow of relatively non volatile electrically conducting liquid into a region at low pressure in which there is an electric field sufficiently intense to disperse emerging liquid into said low pressure region as a spray of small charged droplets;
(b) providing one or more electrodes have configurations, potentials and positions such that said stream of charged droplets will flow in a desired direction at a desired velocity.

2. A method as in claim 1 in which said wick element comprises an aggregate of fibers that are wettable by said liquid.

3. A method as in claim 1 in which said relatively non volatile liquid comprises a very dilute solution of an electrolyte in a solvent taken from the class of organic chemical substances that includes acids, bases, alcohols, amides, glycols, esters, ketones and mixtures containing two or more of these substances.

4. An apparatus capable of operating in vacuo which contains as essential elements:
(a) wick element through which a desired, relatively nonvolatile liquid will migrate by capillarity driven flow,
(b) a means of providing at the exit tip of said wick element an electric field field sufficiently intense to disperse said liquid arriving at the tip of said wick element into a fine spray of charged droplets of said relatively non-volatile liquid
(c) one or more electrodes maintained at potentials sufficient to disperse said arriving liquid at said tip of said wick element into tiny charged droplets and to accelerate said charged droplets into a stream of droplets having a velocity and direction sufficient to provide a reactive thrust at a desired level in a desired direction.
